(19) United States
(12) Patent Application Publication
(10) Pub. No.: US 2013/0303041 A1
(43) Pub. Date: Nov. 14, 2013

(54) COMPOSITE CUSHIONING MATERIAL WITH MULTIPLE STRATA

(71) Applicant: Applied FT Composite Solutions Inc., Las Vegas, NV (US)

(72) Inventor: Daniel Kim, Busan (KR)

(21) Appl. No.: 13/830,622

(22) Filed: Mar. 14, 2013

Related U.S. Application Data
(60) Provisional application No. 61/610,955, filed on Mar. 14, 2012.

(51) Int. Cl. B32B 5/24; A43B 23/00; A43B 7/12

(52) U.S. Cl. CPC B32B 5/24; B32B 5/245; A43B 7/125; A43B 23/00
USPC 442/1; 442/370; 442/372; 442/373

(57) ABSTRACT

The present application discloses a composite material with cushioning qualities, comprising multiple sheeting structures bonded to each other in layers.

### A. BENEFITS OF THE PRESENT INVENTION

The invention relates to a composite material with cushioning qualities, comprising multiple sheeting structures bonded to each other in layers (“strata”). As described in greater detail below, this composite material is lightweight, flexible, breathable, and can be fabricated using relatively inexpensive and/or commonly available materials. Additionally, by varying the type of materials comprising each layer, and their color and dimensions (including thickness and cut patterns), the resulting composite material can be made to display a visually appearing “3D” relief effect. This composite material can be deployed in any uses where a cushioning material or a sheeting structure is required, or where a suitable “3D” visual effect is called for, including, without limitations, footwear, apparel, caps and other headgear, bags, and the like.

### B. SUMMARY OF THE INVENTION

The invention relates to a composite material comprising a plurality of sheeting structures bonded to each other in layers, such as, by way of example only, first composite material 1 depicted in FIGS. 1 and 2A, and second composite material 3 depicted in FIG. 4.

In an embodiment of the invention, the composite material is comprised of two or more sheeting structures bonded to each other in layers, using glue or other means of adhesion, such as a hot-melt adhesive (“HMA”) film. In another advantageous embodiment of the invention, the said composite material is comprised of at least three sheeting structures stacked in layers and bonded to each other.

It is understood that the composite material may be shaped like a flat sheet devoid of any openings or apertures. In an alternative embodiment of the invention, the composite material may incorporate one or more openings or apertures, or a plurality of openings that give the composite material a grid, frame, or matrix-like appearance.

The composition of each layer of material (“stratum”) in the composite material may vary, and each such layer may optionally be comprised of any type of suitable material or combination of materials. Additionally, each layer of material may have any color and dimensions (including thickness, shape, or cut pattern). It is understood that one or more individual layers in the composite material may be comprised of materials of same or different composition, dimension (including thickness, shape, or cut pattern), or color in relation to the other layers. However, in another advantageous embodiment of the invention, at least two of the layers in the composite material are comprised of materials of different color or composition.

### C. BRIEF DESCRIPTION OF THE DRAWINGS

The present invention will become more fully understood from the detailed description given herein below, and the following accompanying drawings, which are given by way of illustration only, and thus are not limitative of the present invention:

FIGS. 1 and 2A depict the composite material.

FIG. 2B depicts an enlarged side view of the composite materials, with multiple sheeting structures bonded to each other in layers.

FIG. 3 depicts an exploded view of the composite material.

FIG. 4 depicts another example of the composite material, as an alternative embodiment of the invention.

FIGS. 5 and 6 depict an article of footwear incorporating the composite material in the upper portion of the footwear.

### D. DESCRIPTION OF THE INVENTION

1. THE COMPOSITE MATERIAL

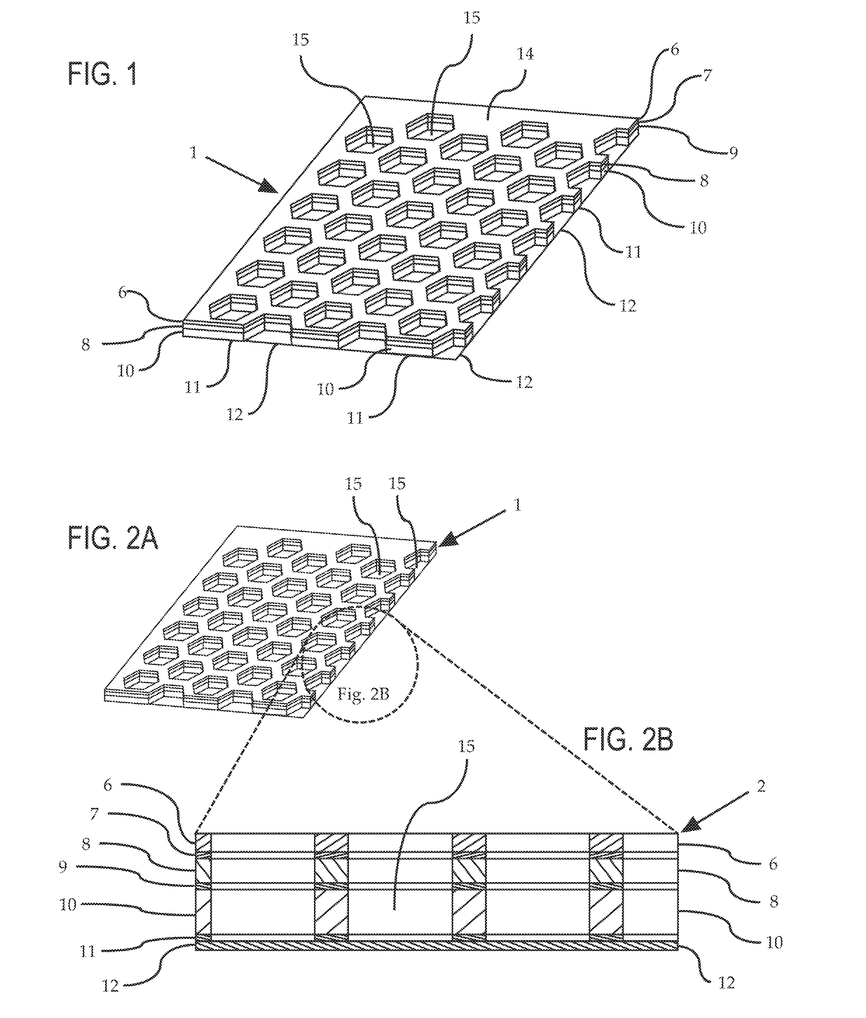

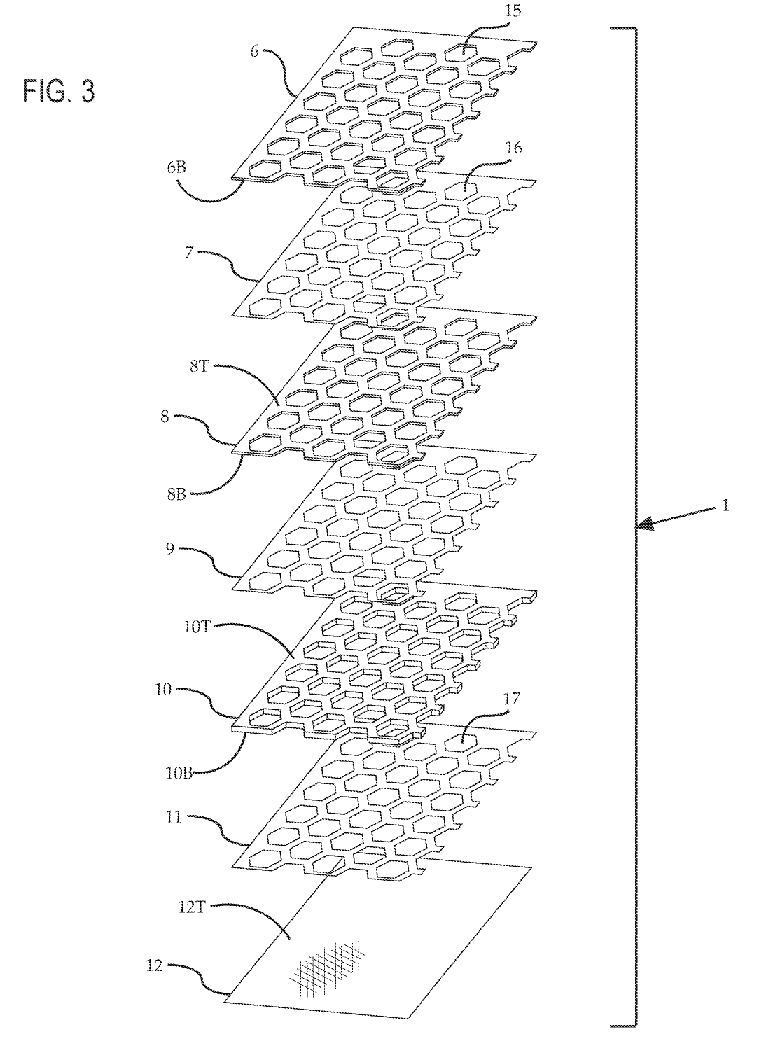

FIGS. 1 and 3 depict first composite material 1, comprising the following:

(1) a first material layer 6, which includes bottom surface 6B;

(2) a second material layer 8, which includes top surface 8T and bottom surface 8B;

(3) a third material layer 10, which includes top surface 10T and bottom surface 10B; and

(4) a fourth material layer 12, which includes top surface 12T.

The layered internal structure of the first composite material 1 is shown in greater detail in FIG. 2B, and in the exploded view depicted in FIG. 3.

It is understood that the composite material (such as the first composite material 1) may have any suitable shape and thickness. It is also understood that the thickness of the composite material may be varied by optionally increasing or decreasing the number of material layers, and/or increasing the thickness of one or more material layers incorporated into the composite material.

2. THE COMPOSITION OF THE LAYERS

In one aspect of the invention, the composition of the first material layer 6, second material layer 8, third material layer 10, and fourth material layer 12 may include, without limitation, any sheeting material, such as thermoplastic polyurethane (“TPU”), synthetic or natural fabric, spandex or elastane, mesh, natural or synthetic leather, or a resilient material, such as a foam or other elastomer, including, without limitations, ethylene vinyl acetate (“EVA”) foam, olefin or polyolefin foam, polyurethane (“PU”) foam, urethane based foam, thermoplastic foam, neoprene, silicone, rubber, or any other material with suitable cushioning characteristics, or resistant to puncture or abrasion, including any combination of such materials. By way of example only, sheets of different materials may be combined by bonding them to each other in vertical layers, or by bonding or sewing swatches made of different types of materials.

Each layer (for example, the first material layer 6, second material layer 8, third material layer 10, and fourth material layer 12) may comprise of the same type of material as the other layers, or may comprise of a material or materials different from that of one or more other layers.

In one advantageous embodiment of the invention, the first material layer 6 comprises a sheet of TPU or PU foam of a suitable thickness; the second material layer 8 comprises a sheet of nonwoven fabric; the third material layer 10 comprises a sheet of EVA foam of a suitable thickness; and the fourth material layer 12 comprises a sheet of synthetic fabric (such as polyester or nylon), spandex or elastane, or open mesh.

If the aforementioned embodiment of the invention, the first material layer 6, the third material layer 10, and the fourth material layer 12 optionally comprise of materials with different colors.

In another aspect of the invention, the visually appearing “3D” relief effect of the composite material may be enhanced by deploying a third material layer 10 (or, alternatively, a first material layer 6 or second material layer 8) of suitable thickness, so that the cross-sectional or side view of the said material layer (and the color thereof) is noticeable to the naked eye, and by selecting first, second, third, and fourth material layers of varying colors, so that at least two of the material layers are of different colors.

As discussed below, in another alternative and optional embodiment of the invention, the first composite material 1 may be fabricated without second material layer 8, in which case the first material layer 6 is layered directly over and adjacent to third material layer 10, and is suitably bonded to the same. In this alternative embodiment of the invention, the first material layer 6 and third material layer 10 must be comprised of a material or materials that can be made to bond to each other.

In another alternative embodiment of the invention, multiple instances, or “swatches,” of a composite material (comprised, for example, of first material layer 6, second material layer 8, and third material layer 10 bonded to each other) may be attached to a single expanse of fourth material layer 12.

3. OPTIONAL APERTURES

FIGS. 1, 2B, and 3 depict the composite material 1 with a plurality of apertures 15, causing the composite material 1 to take on a grid, frame, or matrix-like appearance.

However, it is understood that in an alternative embodiment of the invention, composite material 1 may optionally incorporate a single opening or aperture, or no apertures or openings at all (in which case composite material 1 would have a flat top surface 14 throughout its entire top and bottom surfaces).

It is also understood that, optionally, only some of the material layers may include openings or apertures, and that such openings or apertures may be omitted from one or more layers.

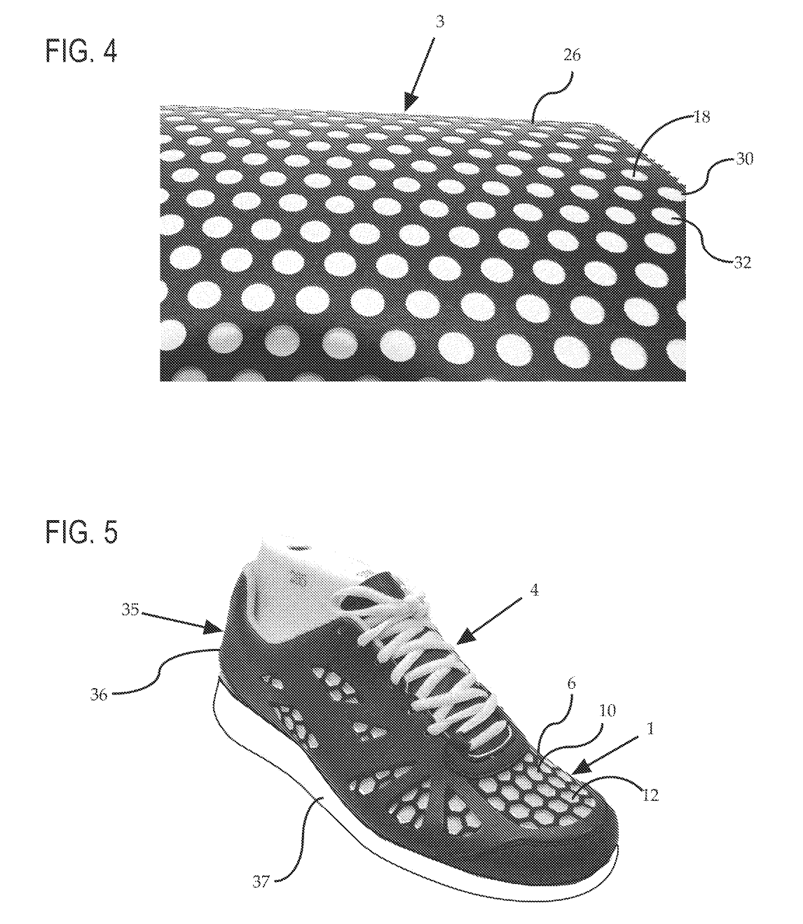

FIGS. 1 and 3 depict a composite material (that is, first composite material 1) with hexagonal apertures (that is, apertures 15) that are uniform in shape and size. However, it is understood that the invention encompasses composite materials optionally with apertures of any size and shape, and composite materials with one or more apertures with non-uniform sizes and shapes (including asymmetrical shapes). By way of example only, FIG. 4 depicts another optional embodiment of the invention, consisting of second composite material 3 with circular apertures 18, and alternative first material layer 26, alternative third material layer 30, and alternative fourth material layer 32.

4. BONDING ELEMENTS JOINING THE MATERIAL LAYERS

The various layers of materials in the composite material 1 are arranged in layers, and made to bond to each other as illustrated in FIGS. 2A and 2B, and FIG. 3. It is understood that, optionally, any compound, adhesive, glue, substance, attachment, or device (such as Velcro or interlocking mechanical means) that permits one material layer to adhere to another adjacent material layer may be used for this purpose.

In an advantageous embodiment of the invention, the various material layers in the first composite material 1 are optionally bonded to each other using hot-melt adhesive (“HMA”) film activated by heat, or by heat and mechanical pressure. By way of example only, as depicted in FIGS. 2B and 3, bottom surface 6B of first material layer 6 is bonded to top surface 8T of second material layer 8 by means of first adhesive layer 7. The bottom surface 8B of second material layer 8 is bonded to top surface 10T of third material layer 10 by means of second adhesive layer 9. The bottom surface 10B of third material layer 10 is bonded to top surface 12T of fourth material layer 12 by means of third adhesive layer 11.

It is understood that in this optional embodiment of the invention, each adhesive layer is comprised of a HMA film (or other suitable adhesive) capable of joining the two adjacent material layers. By way of example only, in reference to the advantageous embodiment described hereinabove, the first adhesive layer 7 may comprise a PU-based HMA film that can suitably bond a PU-based first material layer 6 to the nonwoven fabric in second material layer 8; the second adhesive layer 9 may comprise an EVA or olefin based HMA film that can suitably bond an EVA-based third material layer 10 to the nonwoven fabric material in second material layer 8; and the third adhesive layer 11 may comprises any suitably HMA film (including EVA or olefin based HMA film, or a suitable polyamine based adhesive or glue) that can suitably bond an EVA-based third material layer 10 to the fourth material layer 12.

It is also understood that a suitable glue or adhesive element (such as HMA film) may be selected by its ability to bond the adjacent material layers. By way of example only, in the event that both first material layer 6 and the second material layer 8 are optionally comprised of EVA foam, an EVA or olefin based HMA film may be selected as the first adhesive layer 7, and so forth.

FIG. 3 depicts a plurality of adhesive layers with shapes that optionally correspond to the shapes of the adjacent material layers. By way of example only, and without limitations, first adhesive layer 7 matches the shape of first material layer 6, and incorporates a plurality of apertures 16 that correspond to the shapes of apertures 15 in the first material layer 6. Similarly, third adhesive layer 11 matches the shape of third material layer 10, and also incorporates a plurality of apertures 17. However, it is understood that this is optional, and that the adhesive layers do not have to include apertures, if an adjacent material layer does not include apertures. By way of example only, a flat sheet of HMA film may be applied to the top surface 12T of fourth material layer 12, in order to bond it to third material layer 10.

5. A NON-LIMITING EXAMPLE OF A SUITABLE APPLICATION AND USE OF THE COMPOSITE MATERIAL

In another aspect of the invention, the composite material described hereinabove may be put into any use that calls for a cushioning or sheeting material, including, without limitations, footwear, apparel, caps and other headgear, bags, and the like, and components thereof.

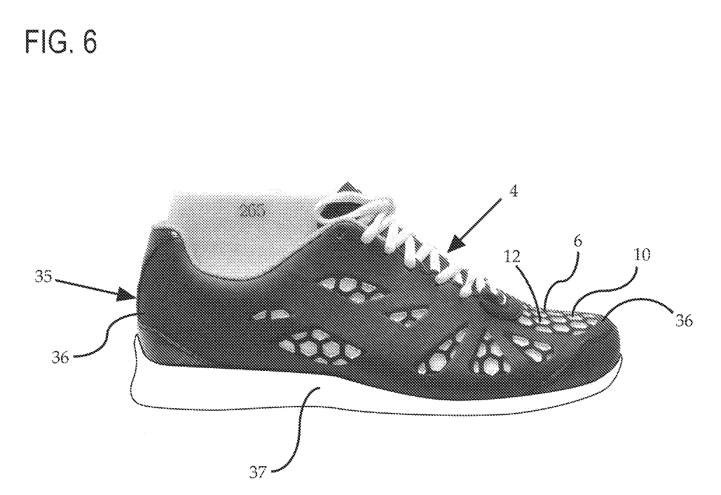

By way of example only, FIGS. 5 and 6 depict an athletic footwear 4 that includes the first composite material 1 in its shoe upper 35. As shown in FIGS. 5 and 6, in this optional embodiment of the invention, the toe box and the sidewall sections of the shoe upper 35 incorporate the first composite material 1, with the first material layer 6 facing the outer surface of the footwear, and the fourth material layer 12 functioning as the inner lining of the shoe. The third material layer 10, sandwiched between the first material layer 6 and fourth material layer 12, function as a cushioning element. As shown in FIGS. 5 and 6, portions of the first composite material 1 in the shoe upper 35 are optionally covered by another layer of thermoplastic polyurethane outer lining or shell 36. The assembled shoe upper 35 is intended to be mounted on, and glued to, the outsole 37.

It is understood that the various materials and components disclosed herein may be made of any suitable material and may be any size and shape consistent with their functions. The specific embodiments of the materials, components, and processes disclosed and illustrated herein are not to be considered in a limiting sense as numerous variations are possible. Ordinal indicators, such as first, second or third, for identified elements in the specification and descriptions herein are used to distinguish between the elements, and do not indicate a required or limited number of such elements, and do not indicate a particular position or order of such elements unless otherwise specifically indicated. The subject matter of this disclosure includes all novel and non-obvious combinations and sub-combinations of the various features, elements, functions and/or properties disclosed herein. No single feature, function, element or property of the disclosed embodiments is essential.

The present invention is not to be limited in scope by the specific embodiments described in this application. Indeed, various modifications of the invention in addition to those described herein will become apparent to those skilled in the art from the foregoing description and accompanying figures. Such modifications are intended to fall within the scope of the disclosures herein. It is understood that the examples disclosed below are offered by way of illustration of the present invention, and not by way of limitation.

What is claimed is:

1. A composite material with cushioning qualities, comprising multiple sheeting structures bonded to each other in layers.

2. The composite material according to claim 1, which is lightweight, flexible, and breathable.
